(19) United States
(12) Patent Application Publication
(10) Pub. No.: US 2013/0159935 A1
(43) Pub. Date: Jun. 20, 2013

(54) GESTURE INPUTS FOR NAVIGATING IN A 3D SCENE VIA A GUI

(71) Applicants: Garrick EVANS, San Francisco, CA (US); Yoshihito KOGA, Mountain View, CA (US); Michael BEALE, Fremont, CA (US)

(72) Inventors: Garrick EVANS, San Francisco, CA (US); Yoshihito KOGA, Mountain View, CA (US); Michael BEALE, Fremont, CA (US)

(21) Appl. No.: 13/329,030

(22) Filed: Dec. 16, 2011

(51) Int. Cl. G06F 3/048

(52) U.S. Cl. 715/850

(57) ABSTRACT

Techniques for manipulating a three-dimensional scene displayed via a multi-touch display include receiving information associated with an end-user touching a multi-touch display at one or more screen locations, determining a hand movement based on the information associated with the end-user touching the multi-touch display, determining a command associated with the hand movement, and causing the three-dimensional to be manipulated based on the command and the one or more screen locations. The disclosed techniques advantageously provide more intuitive and user-friendly approaches for interacting with a 3D scene displayed on a computing device that includes a multi-touch display.

### BACKGROUND OF THE INVENTION

1. Field of the Invention

The present invention relates generally to graphical end-user interfaces in computers and electronic devices and, more specifically, to gesture inputs for navigating in a three-dimensional scene via a graphical end-user interface.

2. Description of the Related Art

Many different ways of interacting with three-dimensional (3D) scenes that are displayed via computing devices are known in the art. Two of the most prevalent approaches involve interacting with the 3D scene via a graphical end-user interface (GUI) displayed on a single-touch display or interacting with the 3D scene using a mouse device in conjunction with a GUI that is configured to recognize “mouse click” commands and cursor movements and may provide various drop-down menu commands. Several problems exist with both of these approaches.

First, with both approaches, selecting an object can be quite challenging and non-intuitive for end-users. With a single-touch display, selecting an object can be difficult because the finger of the end-user is usually large enough to cover multiple small objects simultaneously. Consequently, selecting a single, small object may be impossible or very awkward, requiring the end-user to hold her finger at an unusual angle to make an accurate selection. Similarly, with a mouse device, the end-user may have to place the mouse cursor in a small region to select an object, which can be a slow and error prone process.

Another complication with the above approaches is that slicing through an object in a 3D scene is either not possible or requires the end-user to interact with a complex and non-intuitive set of menu commands. With single-touch displays, oftentimes there is no way to slice through an object. That functionality simply does not exist. With mouse devices, selecting multiple menu and/or “mouse click” commands is required to slice an object. Not only is such a process painstaking for end-users, but many end-users do not take the time to learn how to use the menu and/or “mouse click” commands, so those persons are never able to harness the benefits of such slicing functionality.

General navigation through a 3D scene also is problematic. With both single-touch displays and mouse devices, navigating within a 3D scene usually requires the end-user to select or click on multiple arrows illustrated on the computer screen. Using and selecting arrows is undesirable for end-users, because the arrows take up space on the display and may be obtrusive, covering portions of the 3D scene. Further, the arrows may be available or point in only a few directions—and not in the direction in which the end-user may wish to navigate. Finally, using and selecting arrows typically does not allow the end-user to control the speed of navigation, as each time an arrow is clicked, the navigation takes one “step” in the direction of the arrow. Such a deliberate selection process is inherently slow and tedious. In addition, with most mouse devices, selecting complex and non-intuitive menu and/or “mouse click” commands also is required for navigating a 3D scene. As described above, complex and non-intuitive commands are generally undesirable.

As the foregoing illustrates, what is needed in the art is a more intuitive and user-friendly approach for interacting with a 3D scene displayed via a computing device.

### SUMMARY OF THE INVENTION

One embodiment of the present invention sets forth a method for manipulating a three-dimensional scene displayed on a multi-touch display. The method includes receiving information associated with an end-user touching a multi-touch display at one or more screen locations, determining a hand movement based on the information associated with the end-user touching the multi-touch display, determining a command associated with the hand movement, and causing the three-dimensional to be manipulated based on the command and the one or more screen locations.

One advantage of the techniques disclosed herein is that they provide more intuitive and user-friendly approaches for interacting with a 3D scene displayed on a computing device that includes a multi-touch display. Specifically, the disclosed techniques provide intuitive ways for an end-user to select objects, slice-through objects and navigate within the 3D scene.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments:

FIG. 1 illustrates a computer system configured to implement one or more aspects of the present invention;

FIG. 2 is a more detailed illustration of the memory of the computer system of FIG. 1, according to one embodiment of the present invention;

FIG. 3 is a flow diagram of method steps for manipulating a three-dimensional scene displayed via a multi-touch display, according to one embodiment of the present invention;

FIGS. 4A-4B set forth a flow diagram of method steps for selecting an object in a three-dimensional scene displayed via a multi-touch display, according to one embodiment of the present invention;

FIGS. 4C-4D set forth a flow diagram of method steps for selecting an object in a three-dimensional scene displayed via a multi-touch display, according to another embodiment of the present invention;

FIGS. 5 is a flow diagram of method steps for slicing through an object in a three-dimensional scene displayed via a multi-touch display, according to one embodiment of the present invention; and

FIG. 6 is a flow diagram of method steps for navigating within a three-dimensional scene displayed via a multi-touch display, according to one embodiment of the present invention.

### DETAILED DESCRIPTION

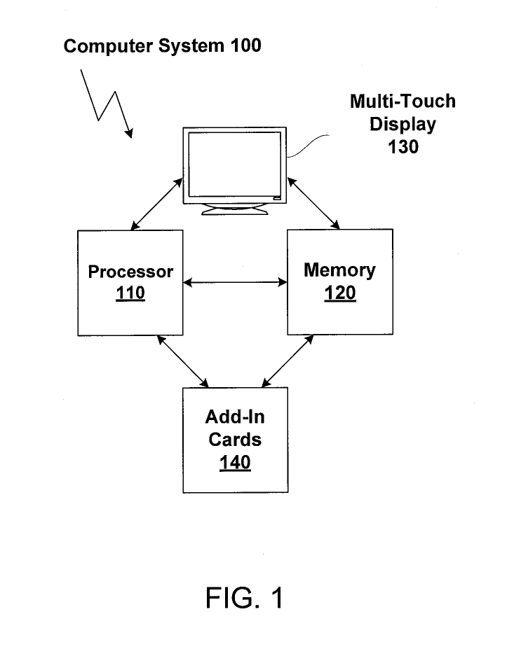

FIG. 1 illustrates a computer system 100 configured to implement one or more aspects of the present invention. The computer system 100 could be implemented in, among other platforms, a desktop computer, laptop computer, a mobile device or a personal digital assistant (PDA) held in one or two hands. As shown, the computer system 100 includes a processor 110, a memory 120, a multi-touch display 130, and add-in cards 140. The processor 110 includes a central processing unit (CPU) and is configured to carry out calculations and to process data. The memory 120 is configured to store data and instructions. The multi-touch display 130 is configured to provide input to and output from the computer system 100. The multi-touch display 130 provides output by displaying images and receives input through being touched by one or more fingers of an end-user and/or by a styli or similar device. The multi-touch display 130 is configured to respond to being touched in more than one screen location simultaneously or in only one screen location at a time. Add-in cards 140 provide additional functionality for the multi-touch screen computer system 100. In one embodiment, add-in cards 140 include one or more of network interface cards that allow the computer system 100 to connect to a network, wireless communication cards that allow the multi-touch screen computer system to communicate via a wireless radio, and/or memory cards that expand the amount of memory 120 available to the multi-touch display.

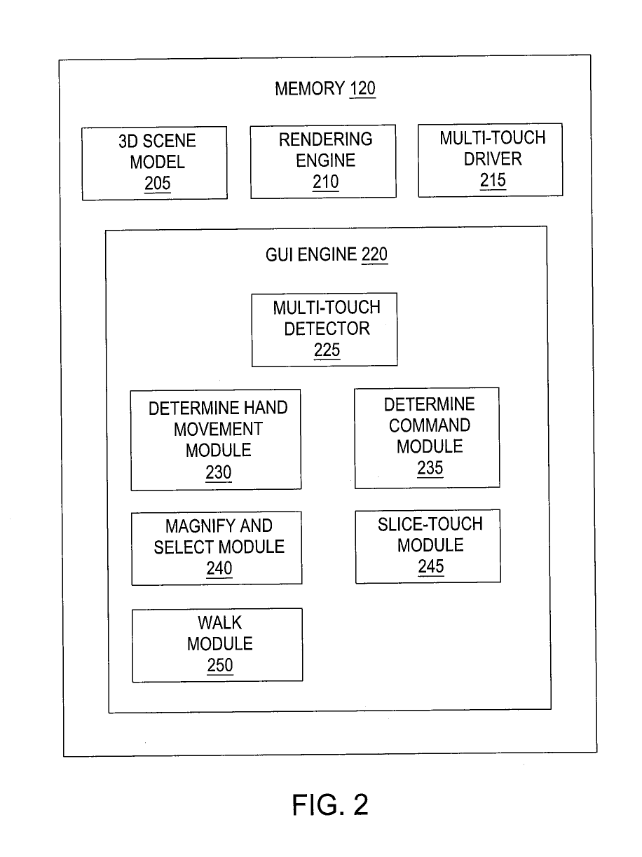

FIG. 2 is a more detailed illustration of the memory 120 of the computer system 100 of FIG. 1, according to one embodiment of the present invention. As shown, the memory 120 includes a 3D scene model 205, a rendering engine 210, a multi-touch driver 215 and a GUI engine 220. The 3D scene model includes a representation of a 3D scene, a portion of which is displayed on the multi-touch display 130. Rendering engine 210 is configured to render the portion of the 3D scene on the multi-touch display 130. Multi-touch driver 215 is configured to receive information associated with an end-user touching or interacting with the multi-touch display 130 in one or more screen locations in various ways.

As shown, the GUI engine 220 includes a multi-touch detector 225, a determine hand movement module 230, a determine command module 235, a magnify and select module 240, a slice-through module 245, a walk module 250, and a rotate module 255. The multi-touch detector 225 is configured to receive multi-touch information associated with an end-user touching or interacting with the multi-touch display 130 in one or more screen locations from the multi-touch driver 215 as well as information regarding the portion of the 3D scene model 205 that is being displayed. The information is then transmitted to the other modules in the GUI engine 220 for further processing, as described in greater detail below. The determine hand movement module 230 determines a particular hand movement of the end-user based on the information associated with the end-user touching or interacting with the multi-touch display 130 that is received by the multi-touch detector 225. The information is then transmitted to the other modules in the GUI engine 220 for further processing.

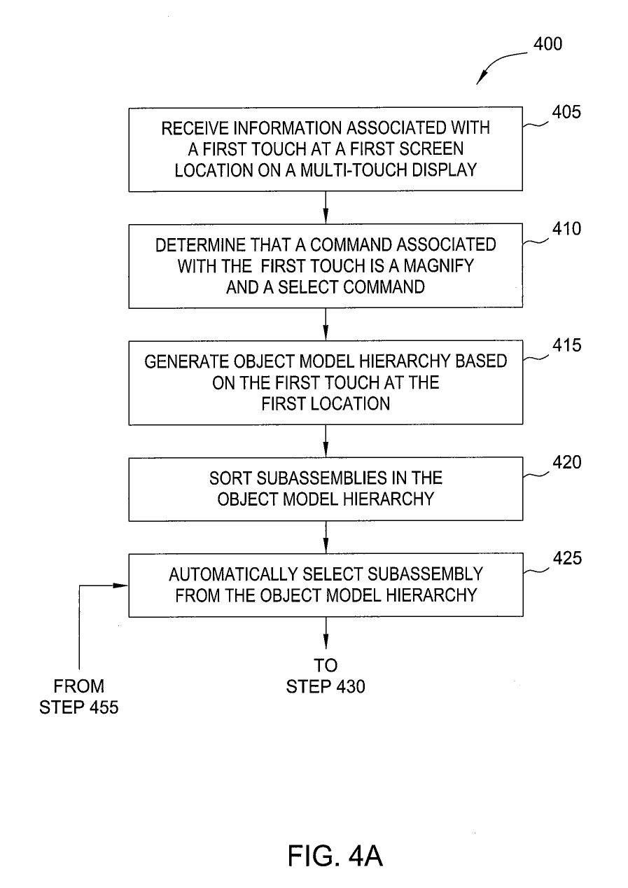

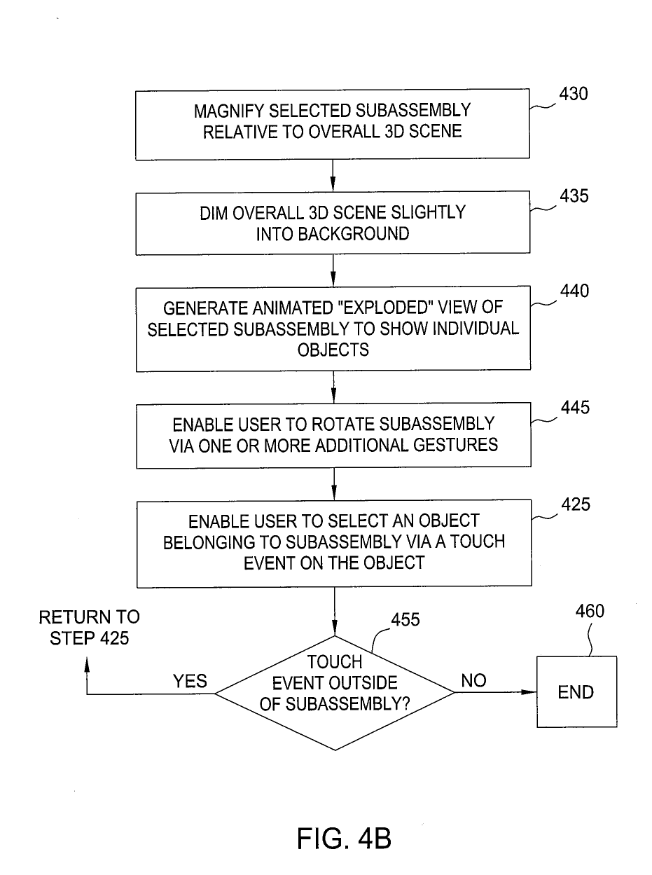

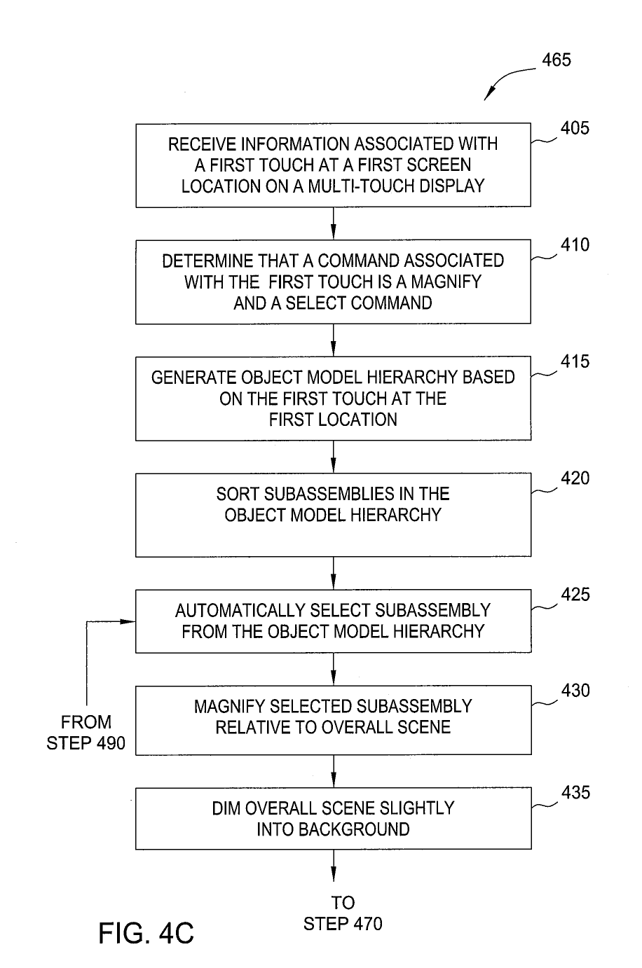

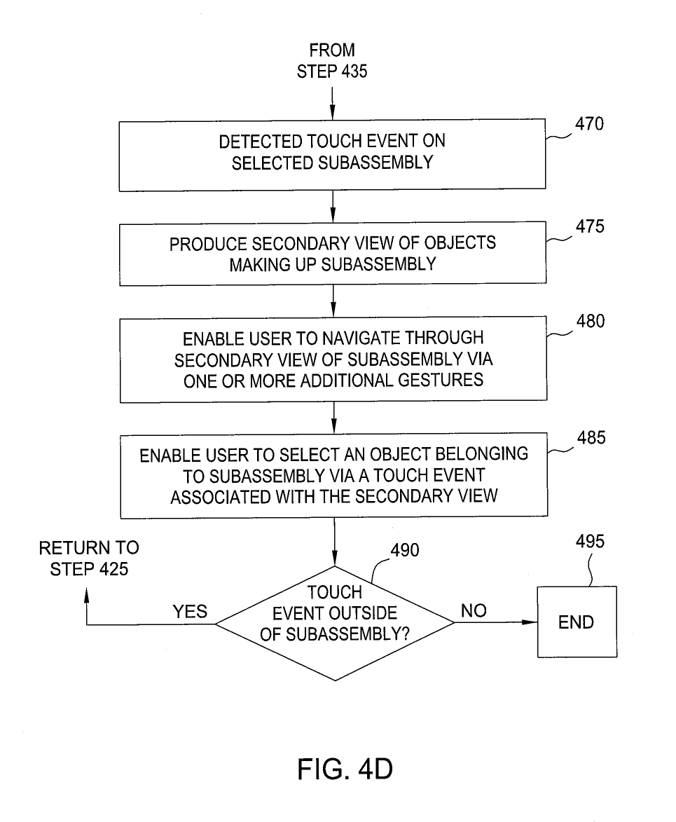

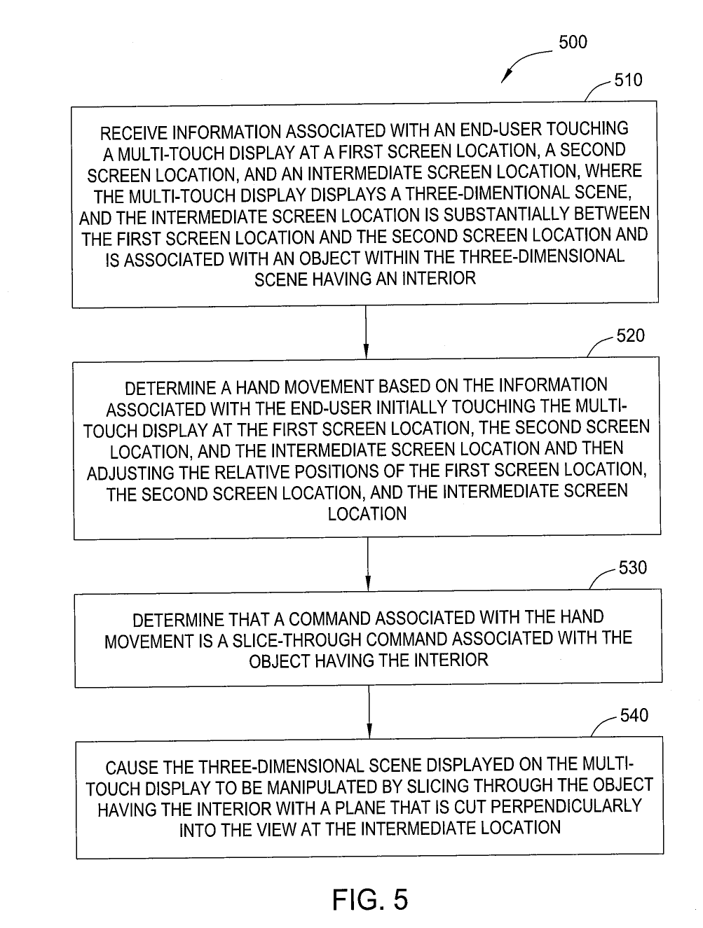

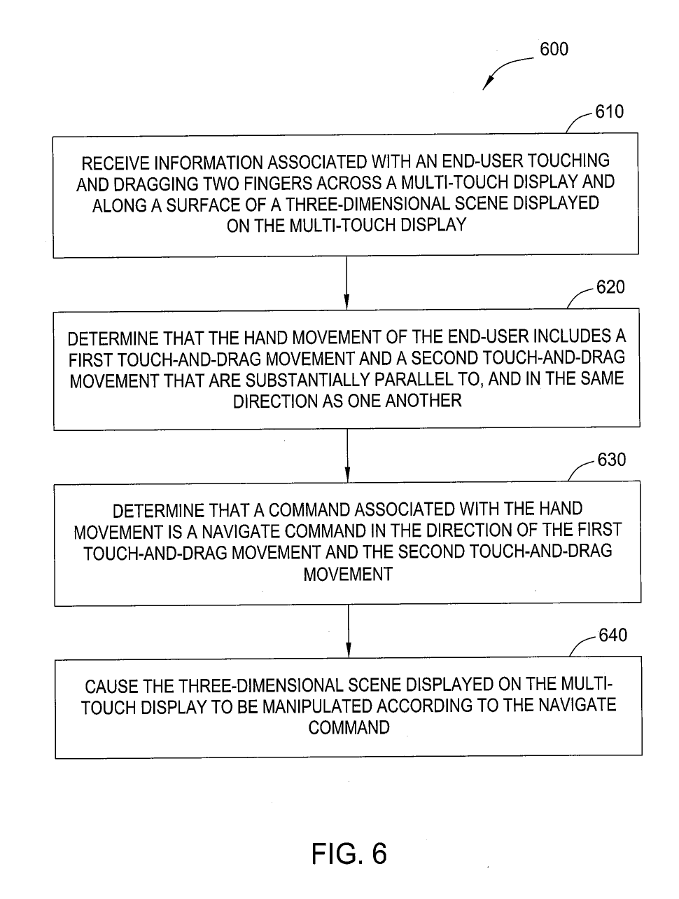

The determine command module 235 is configured to best determine the command that the end-user is attempting to initiate based on the information associated with the end-user touching or interacting with the multi-touch display 130 that is received by the multi-touch detector 225 as well as the hand movement made by the end-user, which is ascertained by the determine hand movement module 235. Various commands that the end-user may attempt to initiate include, among others, a magnify and select command, a slice-through command, and a walk command. Specifically, If the end-user touches a region of the multi-touch display 130 screen near one or more selectable objects, then the determine command module 235 concludes that the command is to magnify and select one of the selectable object and invokes the magnify and select module 240. The magnify and select module 240 then may provide the end-user with one of several ways to select one of the selectable objects. FIGS. 4A-4D, below, provide more specific details about the magnify and select functionality. If the end-user places a first finger on a first side and a second finger on a second side of an object having an interior, and then places a third finger between the first finger and the second finger, then the determine command module 235 concludes that the end-user wishes to slice through the object having the interior and invokes the slice-through module 245. FIG. 5, below, provides more specific details about the slice-through functionality. If the end-user moves two fingers in a walking motion along a surface on the multi-touch display 130, then the determine command module 235 concludes that the command is to navigate within the 3D scene and invokes the walk module 250. FIG. 6, below, provides more specific details about the navigation functionality.

The magnify and select module 240 is configured to cause the multi-touch display 130 to magnify a region having a plurality of selectable objects and to select one of the objects in the plurality of selectable objects. The slice-through module 245 is configured to slice-through an object in the 3D scene and to display the interior of the object. The walk module 250 is configured to navigate within the 3D scene. The rotate module 255 is configured to rotate the 3D scene as displayed on the multi-touch display 130.

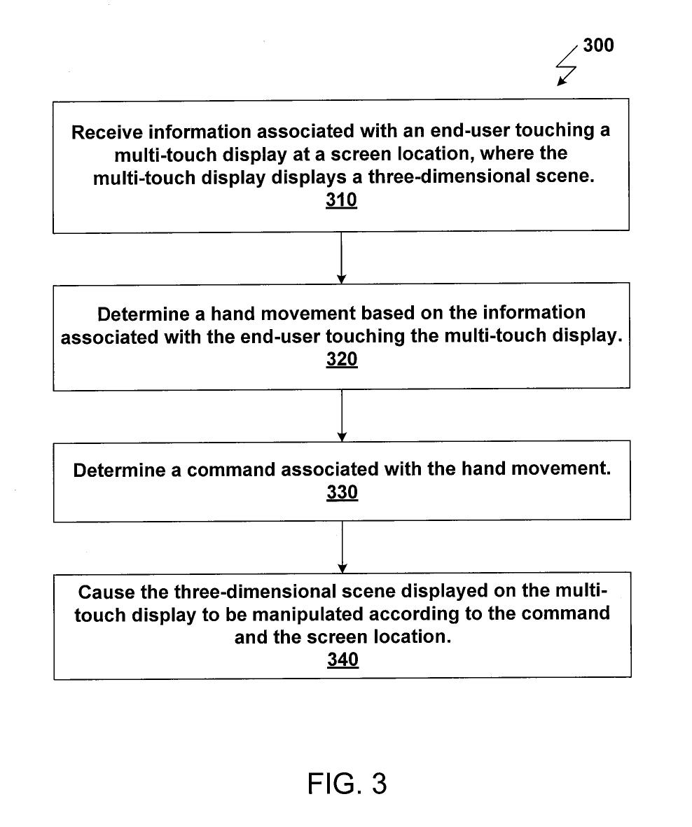

FIG. 3 is a flow diagram of method steps for manipulating a three-dimensional scene displayed via the multi-touch display 130, according to one embodiment of the present invention. Although the method steps are discussed in conjunction with FIGS. 1-2, persons skilled in the art will understand that any system configured to implement the method steps, in any order, falls within the scope of the present invention.

The method 300 begins at step 310, where the multi-touch detector 225 in the GUI engine 220 receives information associated with an end-user touching the multi-touch display 130 at a first screen location, where the multi-touch display 130 displays a 3D scene. In one embodiment, the multi-touch detector 225 receives that information from the multi-touch driver 215.

At step 320, the determine hand movement module 230 in the GUI engine 220 determines a hand movement based on the information associated with the end-user touching the multi-touch display 130. At step 330, the determine command module 235 of the GUI engine 220 determines a command associated with the hand movement.

At step 340, the GUI engine 220 causes the 3D scene displayed on the multi-touch display 130 to be manipulated according to the command and the first screen location. In one embodiment, the rendering engine 210 manipulates the 3D scene displayed on the multi-touch display 130. The method 300 then terminates.

FIGS. 4A and 4B set forth a flow diagram of method steps for selecting an object in a three-dimensional scene displayed via the multi-touch display 130, according to one embodiment of the present invention. Although the method steps are discussed in conjunction with FIGS. 1-2, persons skilled in the art will understand that any system configured to implement the method steps, in any order, falls within the scope of the present invention.

The method 400 begins at step 405, where the multi-touch detector 225 in the GUI engine 220 receives from the multi-touch driver 215 information associated with a first touch at a first screen location on the multi-touch display 130, where the multi-touch display 130 displays a 3D scene. At step 410, the determine command module 235 in the GUI engine 220 determines that the command associated with the first touch is a magnify and select command. The GUI engine 220 then invokes the magnify and select module 240.

At step 415, the magnify and select module 240 generates an object model hierarchy based on a ray cast through the 3D model from the first screen location. In one embodiment, a ray is cast through the 3D model from the first screen location, and each object the ray intersects is identified, and the subassemblies within the 3D model to which those objects belong also are identified. At step 420, the magnify and select module 240 sorts the subassemblies in the object model hierarchy generated at step 415. For example, the subassemblies may be arranged based on their respective depths within the 3D scene, their respective distances from the “camera” generating the 3D scene, or their respective proximities to the touch event (i.e., the first screen location from step 405).

At step 425, the magnify and select module 240 automatically selects a subassembly from the sorted object model hierarchy. In various embodiments, the magnify and select module 240 may use different criteria for this selection. For example, in one embodiment, the subassembly closest to the touch event may be selected, and in another embodiment, the subassembly closest to the camera may be selected. At step 430, the magnify and select module 240 magnifies the selected subassembly relative to the overall 3D scene. At step 435, the magnify and select module 240 causes the overall 3D scene to be dimmed into the background relative to the magnified subassembly. At step 440, the magnify and select module 240 generates an animated “exploded” view of the magnified subassembly to show each of the individual objects belonging to the subassembly.

At step 445, the magnify and select module 240 configures the exploded subassembly to enable an end-user to rotate the subassembly via one or more additional gestures applied to the multi-touch display 130. At step 450, the magnify and select module 240 configures the exploded subassembly to enable an end-user to select one or more of the objects within the exploded subassembly via a touch event (i.e., the user touching the multi-touch display 130) on one or more of those objects.

At step 450, the magnify and select module 240 determines whether there is an additional touch event outside the exploded view of the subassembly. If there is no touch event outside the exploded view of the subassembly, then the method 400 terminates at step 460 once the end-user has completed selecting individual objects within the exploded subassembly. However, if there is a touch even outside the exploded view of the subassembly, then the method returns to step 425, where another subassembly from the object model hierarchy is selected.

FIGS. 4C and 4D set forth a flow diagram of method steps for selecting an object in a three-dimensional scene displayed via the multi-touch display 130, according to another embodiment of the present invention. Although the method steps are discussed in conjunction with FIGS. 1-2, persons skilled in the art will understand that any system configured to implement the method steps, in any order, falls within the scope of the present invention.

As shown, the first several steps of the method 465 are similar to the first several steps of the method 400. More specifically, steps 405, 410, 415, 420, 425, 430, and 435 are common to both methods and will not be further discussed in the context of the method 465. However, after the overall 3D scene is dimmed into the background at step 435, the method 465 proceeds to step 470.

At step 470, the magnify and select module 240 determines that a touch event has occurred on the subassembly selected at step 435. In response, at step 475, the magnify and select module 240 produces a secondary view of the objects making up the selected subassembly. In one embodiment, the secondary view comprises a node tree of the subassembly, where the top-level or toot note is the subassembly, and each object in the subassembly is either another node or a leaf in the node tree. As is well-understood, the nodes of the node tree may be presented to the end-user in collapsed form, and the user may select a particular node in the tree to have that node expanded so the user can see the other sub-nodes and/or leaves related to a particular node. In this fashion, the end-user can manipulate the node tree representation of the subassembly and determine the different objects making up the subassembly. In another embodiment, the secondary view comprises a “flattened” representation of the subassembly where all of the geometry of the subassembly (i.e., the objects making up the subassembly) has been opened and is presented to the end-user. The end-user can then scroll up and down the flattened representation to view all different objects making up the subassembly.

At step 480, the magnify and select module 240 configures the secondary view of the subassembly to enable an end-user to navigate through the secondary view of the subassembly via one or more additional gestures (i.e., where the user interacts with the multi-touch display 130 using one or more additional finger gestures). At step 485, the magnify and select module 240 configures the secondary view of the subassembly to enable an end-user to select one or more of the objects within the subassembly via a touch event (i.e., the user touching the multi-touch display 130) associated with the secondary view. For example, the end-user may touch the multi-touch display 130 at a location associated with a node or leaf in the node tree representation of the subassembly or associated with an object set forth in the flattened representation of the subassembly. Again, the combination of steps 480 and 485 enable the end-user to navigate through a node tree or “flattened” representation of the subassembly via one or more additional finger gestures on the multi-touch display 130 and to select a particular object making up the subassembly by touching the multi-touch display 130 at a location corresponding to that object in either the tree node representation or the flattened representation of the subassembly.

The method 465 then proceeds to step 490, where the magnify and select module 240 determines whether there is an additional touch event outside the secondary view of the subassembly. If there is no touch event outside the secondary view of the subassembly, then the method 465 terminates at step 495 once the end-user has completed selecting individual objects within the secondary view of the selected subassembly. However, if there is a touch even outside the secondary view of the subassembly, then the method returns to step 425, where another subassembly from the object model hierarchy is selected.

FIGS. 5 is a flow diagram of method steps for slicing through an object in a three-dimensional scene displayed via the multi-touch display 130, according to one embodiment of the present invention. Although the method steps are discussed in conjunction with FIGS. 1-2, persons skilled in the art will understand that any system configured to implement the method steps, in any order, falls within the scope of the present invention.

The method 500 begins at step 510, where the multi-touch detector 225 in the GUI engine 220 receives from the multi-touch driver 215 information associated with an end-user touching the multi-touch display 130 at a first screen location, a second screen location, and an intermediate screen location, where the multi-touch display 130 displays a 3D scene having at least one object that has an interior. The intermediate screen location is between the first screen location and the second screen location and is associated with one of the objects in the 3D scene having an interior.

At step 520, the determine hand movement module 230 in the GUI engine 220 determines a hand movement based on the information associated with the end-user touching the multi-touch display 130 in the manner set forth above and adjusting the locations on the screen of one or more of the first screen location, the second screen location, and the intermediate screen location. At step 530, the determine command module 235 in the GUI engine 220 determines that the command associated with the particular hand movement described above is a slice-through command associated with the object having the interior. The GUI engine 220 then invokes the slice-through module 245.

At step 540, the slice-through module 245 causes the 3D scene displayed on the multi-touch display 130 to be manipulated by slicing-through the object having the interior. In one embodiment, a slicing plane is cut perpendicularly into the view (i.e., the 3D scene) at the intermediate screen location. In alternative embodiments, the slicing plane may be defined in any technically feasible fashion. The method 500 then terminates.

FIG. 6 is a flow diagram of method steps for navigating within a three-dimensional scene displayed via the multi-touch display 130, according to one embodiment of the present invention. Although the method steps are discussed in conjunction with FIGS. 1-2, persons skilled in the art will understand that any system configured to implement the method steps, in any order, falls within the scope of the present invention.

The method 600 begins at step 610, where the multi-touch detector 225 in the GUI engine 220 receives from the rendering engine 210 information associated with the end-user touching and dragging two fingers across the multi-touch display 130 and along a surface of the 3D scene displayed via the multi-touch display 130. The GUI engine 220 then invokes the determine hand movement module 230.

At step 620, based on the end-user's touching and dragging described above, the determine hand movement module 230 in the GUI engine 220 determines that the hand movement of the end-user includes a first touch-and-drag movement and a second touch-and-drag movement that are substantially parallel to, and in the same direction as, one another. The GUI engine then invokes the determine command module 235. One should note that a touch-and-drag movement, as referred to herein, involves touching one location on the screen of the multi-touch display 130 and dragging a finger, stylus or other object that implements one touching across the multi-touch display 130. Thus, with touching and dragging two fingers, there are two different touch-and-drag movements detected by the multi-touch display 130.

At step 630, the determine command module 235 in the GUI engine 220 determines that the command associated with the touching and dragging described above is a navigate command or a walk command in the direction of the first and the second touch-and-drag movements. The GUI engine 220 then invokes the walk module 250.

At step 640, the walk module 250 of the GUI engine 220 causes the 3D scene displayed on the multi-touch display 130 to be manipulated according to the navigate/walk command. In one embodiment, in so doing, the walk module 250 of the GUI engine 220 causes the rendering engine 210 to render a portion of the 3D scene translated from the previously rendered portion of the 3D scene in the direction of the first and the second touch-and-drag movements. The method 600 then terminates.

In sum, the techniques disclosed above provide more efficient ways for an end-user to interact with a 3D displayed via a multi-touch display. Among other things, the disclosed techniques enable an end-user to select an object, slice through an object, navigate within a 3D scene more effectively when interacting with a 3D scene or model displayed on multi-touch display device. With each of the techniques, an end-user touches the multi-touch display screen in a particular manner, the hand movement of the user is ascertained based on information associated with how the end-user touches the multi-touch display screen, a command is determined based on the ascertained hand movement, and then the 3D scene is manipulated according to the command.

Advantageously, the techniques disclosed herein provide user-friendly and intuitive techniques for an end-user to select an object in a 3D scene, slice through an object in the 3D scene to view the interior of the object, navigate within the 3D scene, and rotate the viewpoint associated with the 3D scene. Each of these interactions is implemented by the user touching a multi-touch display in a manner that is intuitively related to the particular interaction and require cumbersome menus or on-screen arrows.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

The scope of the present invention is determined by the claims that follow.

What is claimed is:

1. A method for manipulating a three-dimensional scene displayed via a multi-touch display, the method comprising:
receiving information associated with an end-user touching a multi-touch display at one or more screen locations;
determining a hand movement based on the information associated with the end-user touching the multi-touch display;
determining a command associated with the hand movement; and
causing the three-dimensional to be manipulated based on the command and the one or more screen locations.

2. The method of claim 1, wherein:
the hand movement comprises a touch at a first screen location;
the command is determined to be a magnify and select command based on the hand movement being a touch at the first screen location; and
causing comprises magnifying a subassembly associated with the three-dimensional scene, wherein the subassembly is selected from an object model hierarchy generated based on the first screen location.

3. The method of claim 2, wherein causing further comprises generating an exploded view of the subassembly and enabling the end-user to select an object associated with the subassembly via a touch event associated with the object.

4. The method of claim 2, wherein causing further comprises generating a secondary view of the subassembly and enabling the end-user to select an object associated with the subassembly via a touch event associated with the secondary view.

5. The method of claim 4, wherein the secondary view comprises a node tree representation of the subassembly or a flattened representation of the subassembly.

6. The method of claim 1, wherein:
the three-dimensional scene includes an object having an interior;
the hand movement includes a touch at a first screen location, a touch at a second screen location, and a touch at an intermediate screen location that is substantially between the first screen location and the second location and is associated with the object having the interior;
the command is determined to be a slice-through command associated with the object having the interior.

7. The method of claim 6, wherein causing the three-dimensional scene to be manipulated comprises slicing the object having the interior with a slicing plan associated with the intermediate screen location.

8. The method of claim 7, wherein the slicing plane is cut perpendicularly into the three-dimensional scene at the intermediate screen location.

9. The method of claim 1, wherein the hand movement comprises a first touch-and-drag movement across the multi-touch display and along a surface of the three-dimensional scene and a second touch-and-drag movement across the multi-touch display and along the surface of the three-dimensional scene, and wherein the first touch-and-drag movement is substantially parallel to the second touch-and-drag movement.

10. The method of claim 9, wherein the command associated with the hand movement is determined to be a walk command in a direction of the first touch-and-drag movement and the second touch-and-drag movement.

11. A non-transitory computer-readable medium storing instructions that, when executed by a processing unit, cause the processing unit to manipulate a three-dimensional scene displayed via a multi-touch display, by performing the steps of:
receiving information associated with an end-user touching a multi-touch display at one or more screen locations;
determining a hand movement based on the information associated with the end-user touching the multi-touch display;
determining a command associated with the hand movement; and
causing the three-dimensional to be manipulated based on the command and the one or more screen locations.

12. The non-transitory computer-readable medium of claim 11, wherein:
the hand movement comprises a touch at a first screen location;
the command is determined to be a magnify and select command based on the hand movement being a touch at the first screen location; and
causing comprises magnifying a subassembly associated with the three-dimensional scene, wherein the subassembly is selected from an object model hierarchy generated based on the first screen location.

13. The non-transitory computer-readable medium of claim 12, wherein causing further comprises generating an exploded view of the subassembly and enabling the end-user to select an object associated with the subassembly via a touch event associated with the object.

14. The non-transitory computer-readable medium of claim 12, wherein causing further comprises generating a secondary view of the subassembly and enabling the end-user to select an object associated with the subassembly via a touch event associated with the secondary view.

15. The non-transitory computer-readable medium of claim 14, wherein the secondary view comprises a node tree representation of the subassembly or a flattened representation of the subassembly.

16. The non-transitory computer-readable medium of claim 11, wherein:
the three-dimensional scene includes an object having an interior;
the hand movement includes a touch at a first screen location, a touch at a second screen location, and a touch at an intermediate screen location that is substantially between the first screen location and the second location and is associated with the object having the interior;
the command is determined to be a slice-through command associated with the object having the interior.

17. The non-transitory computer-readable medium of claim 16, wherein causing the three-dimensional scene to be manipulated comprises slicing the object having the interior with a slicing plan associated with the intermediate screen location.

18. The non-transitory computer-readable medium of claim 17, wherein the slicing plane is cut perpendicularly into the three-dimensional scene at the intermediate screen location

19. The non-transitory computer-readable medium of claim 11, wherein the hand movement comprises a first touch-and-drag movement across the multi-touch display and along a surface of the three-dimensional scene and a second touch-and-drag movement across the multi-touch display and along the surface of the three-dimensional scene, and wherein the first touch-and-drag movement is substantially parallel to the second touch-and-drag movement.

20. The non-transitory computer-readable medium of claim 19, wherein the command associated with the hand movement is determined to be a walk command in a direction of the first touch-and-drag movement and the second touch-and-drag movement.

21. A computing device, comprising:
a multi-touch display configured to display a three-dimensional scene; and
a processing unit configured to:
receive information associated with an end-user touching a multi-touch display at one or more screen locations,
determine a hand movement based on the information associated with the end-user touching the multi-touch display,
determine a command associated with the hand movement, and
cause the three-dimensional to be manipulated based on the command and the one or more screen locations.

22. The system of claim 21, further comprising a memory that includes instructions that, when executed by the processing unit, cause the processing unit to receive the information, determine the hand movement, determine the command, and cause the three-dimensional scene to be manipulated.
